(19) United States
(12) Patent Application Publication
(10) Pub. No.: US 2017/0186532 A1
(43) Pub. Date: Jun. 29, 2017

(54) Current Transformer

(71) Applicant: ABB Schweiz AG, Baden (CH)

(72) Inventor: Henrik Breder, Västerås (SE)

(21) Appl. No.: 15/312,902

(22) PCT Filed: May 12, 2015
(86) PCT No.: PCT/EP2015/060510

§ 371 Date: Nov. 21, 2016

(30) Foreign Application Priority Data
Jun. 10, 2014 (EP) 14171822.1

(51) Int. Cl. H01F 27/32; H01F 38/30

(52) U.S. Cl. CPC H01F 27/321; H01F 38/30

(57) ABSTRACT

A current transformer including a bushing, a primary conductor extending inside the bushing, which is electrically insulated, and includes a hairpin portion arranged outside the bushing, a tube arranged around the primary conductor along the hairpin portion, an electrically insulating material arranged in the tube, which electrically insulating material is arranged around the primary conductor insulation in the hairpin portion, a core arranged around the tube, and a secondary winding wound around the core.

### TECHNICAL FIELD

The present disclosure generally relates to devices for measuring electrical parameters. In particular, it relates to current transformers.

### BACKGROUND

Current transformers (CTs) are utilised in power systems, for example in a substation environment, for measuring the current of a conductor such as a high voltage conductor. Current transformers may thus comprise a primary conductor which is electrically connectable to a conductor of the power system, one or more cores arranged around the primary conductor, and windings wound around the core(s). When a magnetic field is induced in the core(s) by the current flowing through the primary conductor, a current with an amplitude which is directly proportional to the primary conductor current is induced in the winding, the induced current having an amplitude dependent of the number of turns of the windings. The current flowing through the windings, which typically is substantially lower than the current flowing in the primary conductor, can thus be measured. By knowledge of the number of turns of the windings, the current flowing through the primary conductor and thus through the conductor of the power system may be determined.

A current transformer for power system applications typically comprises a bushing into which a power system conductor that is to be subjected to current measurements is lead. The current transformer normally also comprises a tank in which the cores are contained. For high voltage applications and very high voltage applications both the bushing and the tank are filled with an insulating liquid such as oil. Dry current transformers are similar in structure to the insulating liquid-filled current transformers but differ in that neither the bushing nor the tank contains insulating liquid. The bushing and tank of a dry current transformer may typically comprise a gas such as SF₆. An example of a dry-type current transformer is disclosed in CN102938309.

### SUMMARY

Current transformers comprising an insulating liquid are suitable for very high voltage applications, but the amount of insulating liquid may prove to be disadvantageous in the event of a failure, in production, and in transportation where the weight of the liquid, e.g. oil, increases the total weight of the current transformer. Dry current transformers, which are lighter than oil-filled current transformers are on the other hand not suitable for very high voltage applications.

In view of the above, an object of the present disclosure is to provide a current transformer which solves or at least mitigates existing problems of the prior art.

There is hence provided a current transformer comprising a bushing, a primary conductor extending inside the bushing, which primary conductor is electrically insulated with a primary conductor insulation, and which primary conductor comprises a hairpin portion which is arranged outside the bushing, a tube arranged around the primary conductor along the hairpin portion, an electrically insulating material arranged in the tube, which electrically insulating material is arranged around the primary conductor insulation in the hairpin portion, a core arranged around the tube, and a secondary winding wound around the core.

By utilising a tube which contains an electrically insulating material, the tank containing the core, and the insulating fluid in the tank in case of a high voltage application, can be discarded thus reducing the amount of insulation material compared to fluid-filled tanks, while adequate electrical insulation for high voltage applications and even very high voltage applications may be obtained. Moreover, replacement of the core is simplified as is the addition of a core, since the hairpin portion is readily accessible without having to empty oil to enable access.

According to one embodiment the electrically insulating material comprises a dielectric liquid. By providing a dielectric liquid in the tube liquid electrical insulation similar to the insulation provided in prior art dielectric liquid-filled tanks may be obtained with a smaller volume of dielectric liquid. Furthermore, since the core and windings are arranged outside the tube and thus outside the dielectric liquid, no seals are required for the windings as they are led to measurement equipment. In contrast previous solutions where the core(s) and windings are immersed in dielectric liquid an additional sealing system was required to lead the windings out from the tank.

According to one embodiment the dielectric liquid contained in the tube is oil. An example of a suitable oil is transformer oil.

According to one embodiment the electrically insulating material comprises a quartz filling. Quartz has good electrical insulation properties, and if the electrically insulating material also comprises dielectric liquid, the quartz filling minimizes the amount of dielectric liquid. Furthermore, it provides mechanical support of the primary conductor during transport and in the event of a short circuit.

According to one embodiment the primary conductor is hollow and has an inner channel along the entire primary conductor, wherein the current transformer comprises a dielectric liquid in the inner channel, arranged to circulate in the primary conductor. Cooling of the primary winding may thus be obtained.

According to one embodiment the primary conductor insulation comprises paper and foil.

One embodiment comprises a frame assembly, wherein the hairpin portion is arranged within the frame assembly, wherein the frame assembly defines an open casing of the hairpin portion. By providing the hairpin portion in an open frame assembly/casing the hairpin portion and the core may be accessed in a simple manner without having to open a tank. Core replacement may thus be facilitated and/or installation of additional cores for monitoring and diagnostics.

According to one embodiment the tube is attached to the frame assembly.

According to one embodiment the tube is flexible enough to enable threading of the tube onto the hairpin portion of the primary conductor.

According to one embodiment the tube is made of stainless steel.

According to one embodiment the bushing is filled with a dielectric fluid.

According to one embodiment the dielectric fluid is oil.

According to one embodiment the bushing is filled with air.

According to one embodiment the current transformer is a high voltage current transformer.

Generally, all terms used in the claims are to be interpreted according to their ordinary meaning in the technical field, unless explicitly defined otherwise herein. All references to “a/an/the element, apparatus, component, means, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 shows a schematic side view of an example of a current transformer;

FIG. 2 depicts a side view of the current transformer in FIG. 1 with the bushing removed to expose the primary conductor; and

FIG. 3 shows a sectional view of a portion of the hairpin portion of the current transformer in FIG. 1.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

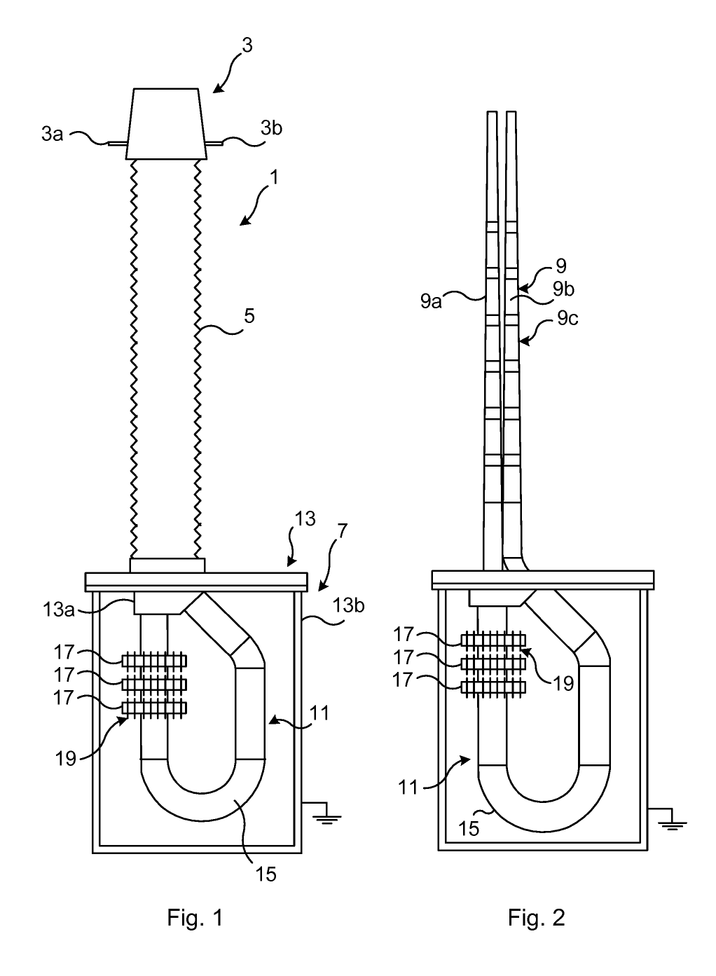

FIG. 1 shows an example of a current transformer 1 which comprises a top part 3 having a first terminal 3a and a second terminal 3b which are arranged to be connected to a conductor of a power system, for example in a substation environment. The current transformer 1 further comprises a bushing 5 assembled with the top part 3 at one end of the bushing 5, and a measurement assembly 7 arranged outside the bushing 5, at the other end of the bushing 5. The measurement assembly 7 includes one or more sensors for current measurements, as will be described in more detail below.

FIG. 2 depicts the current transformer 1 with the bushing and the top part 3 removed, thus exposing the interior of the current transformer 1. The current transformer 1 comprises a primary conductor 9 which extends through the bushing 5 and which electrically connects with the first terminal 3a and the second terminal 3b of the top part 3. This connection is not shown in FIG. 2. The current transformer 1 may thereby be connected in series with a conductor in a power system, wherein current from the conductor in the power system may flow through the primary conductor 9 to enable current measurements by means of the current transformer 1.

The primary conductor 9 furthermore has a hairpin portion 11 outside the bushing 5. The hairpin portion 11 is defined as the portion which extends outside the bushing 5. The hairpin portion 11 is curved such that the primary conductor 9 can be lead back into the bushing 5. The primary conductor 9 thus comprises two essentially parallel portions 9a and 9b extending inside the bushing 5 and the hairpin portion 11, which provides an essentially 180° turn of the primary conductor 9 and links or connects the two essentially parallel portions 9a and 9b.

The current transformer 1 comprises a primary conductor insulation 9c, which provides electrical insulation of the primary conductor 9. The primary conductor insulation 9c may for example comprise paper and foil, e.g. aluminium foil, which is wound around the primary conductor 9. According to one variation, the entire length of the primary conductor 9, i.e. the two essentially parallel portions 9a and 9b as well as the hairpin portion 11, is electrically insulated by means of the primary conductor insulation 9c.

The current transformer 1 further comprises a tube 15 which is arranged around the hairpin portion 11 and thus the primary conductor insulation 9c which covers the primary conductor 9 in the hairpin portion 11. The tube 15 may comprise a single flexible tube which is thread around the hairpin portion 11. Alternatively, the tube 15 may comprise a plurality of flexible tube parts which may be thread around the hairpin portion 11 or which may be halves assembled from two sides of the hairpin portion 11, and which may be joined together, for example by means of welding. By providing a tube comprising a plurality of flexible tube parts, assembly of the tube 15 onto the hairpin portion 11 may be facilitated. In general the tube is made of a material that is flexible enough to enable threading of the tube 15 onto the hairpin portion 11 of the primary conductor 9. The tube 15 may for example be made of metal such as stainless steel or any other material which has high mechanical strength, and does not necessarily have to be a magnetic material or electrically conducting material; it could for example be made of an electrically insulating material, e.g. plastic. Preferably, however, the tube 15 should be made of an electrically conducting material such as a metal. Such tubes are readily available, and the flexibility depends e.g. on the thickness dimension of the tube and the particular material of which the tube is manufactured. Suitable flexible tubes made of metal such as stainless steel are commercially available.

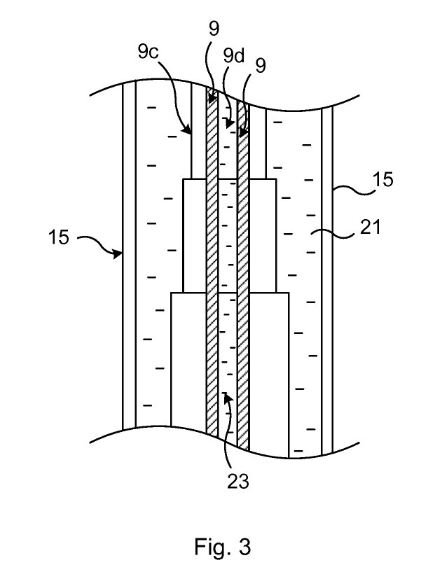

The tube 15 is dimensioned such that it is distanced from the primary conductor insulation 9c, wherein a space is formed therebetween. An electrically insulating material 21, as shown in FIG. 3, can thus be arranged in the tube 15 around the primary conductor insulation 9c in the hairpin portion 11. The current transformer 1 hence comprises an electrically insulating material 21 arranged in the tube 15 between the inner surface of the tube 15 and the primary conductor insulation 9c. The electrically insulating material 21 may for example comprise a dielectric liquid such as oil, and/or a quartz filling.

The current transformer 1 may further comprise one or more cores 17 arranged around the tube 15, and windings 19 wound around the core(s) 17. Each core 17 defines a magnetic circuit and is constructed such that magnetic flux is generated in the core 17 when current flows through the hairpin portion 11 of the primary conductor 9. Current is thereby induced in the windings 17 which are connectable to measurement equipment for determining the current flowing through the windings 19 and thus the current flowing through the primary conductor 9. Since the current flowing through the primary conductor is the current flowing through the particular conductor on which the current measurements of interest are carried out, the conductor current may be determined.

Each core 17 may be made of strips of magnetic material wound in a plurality of layers in the radial direction, or alternatively by means of a plurality of laminated sheet with the sheet being arranged in the axial direction. The axial direction is defined by the longitudinal extension of the primary conductor around which the core(s) are arranged.

The tube 15, the core(s) 17, the windings 19 and the hairpin portion 11 define the measurement assembly 7, which thus enable current measurements of a conductor in the electrical grid.

The current transformer 1 may according to one variation comprise a frame assembly 13, including a flange connection tray 13a to which the tube 15 may be connected. In particular both open ends of the tube 15 may be connected to the flange connection tray 13a. The tube 15 may for example be connected to the flange connection tray 13a via a cone clutch coupling at each end of the tube 15. The coupling between the tube 15 and flange connection tray 13a may be sealed by means of one or more seals such that the tube 15 may form a closed system for the electrically insulating material 21. The flange connection tray 13a has an opening through which the primary conductor 9, i.e. parts 9a and 9b, are lead out from/into the bushing 5. The bushing 5 may according to this variation be mounted to the flange connection tray 13a. In an assembled state the hairpin portion 11 is arranged outside the bushing 5, suspended from the flange connection tray 13. Upon installation of the current transformer 1, the flange connection tray 13a is connected to ground.

The frame assembly 13 may according to one variation further comprise a frame 13b. The frame 13b may form an open cover of the measurement assembly 7. The frame 13b may thus function as an open housing leaving the tube 15 externally visible and accessible, in contrast to prior art tank solutions which are closed off. The frame 13b allows direct access to the measurement assembly 7. The flange connection tray 13a may be a separate piece which can be assembled with the frame 13b or may alternatively be an integrated portion of the frame 13b. As an alternative to a frame which defines an open cover/housing, the current transformer could comprise a tank with walls, which defines a closed cover or housing of the hairpin portion.

As shown in FIG. 3, the primary conductor 11 may be hollow, preferably along its entire length, such that an inner channel 9d is formed in the primary conductor 11 along its entire length. The current transformer 1 may comprise a dielectric liquid 23 arranged in the inner channel 9d. The dielectric liquid 23 may thus circulate in the primary conductor 9, including the hairpin portion 11, thus enabling cooling of the primary conductor 9.

The bushing 5 may according to one variation be filled with a dielectric fluid such as oil or a gas, for example SF₆, and optionally also with quartz filling. The bushing 5 may alternatively comprise air, i.e. be filled with air. In case the current transformer 1 is filled with a dielectric gas or with air the current transformer 1 is essentially a dry current transformer but with additional electrical insulation in the hairpin portion 11.

The current transformers described herein may beneficially be utilised for current measurements in for example a power transmission network or a power distribution network, for example in a substation environment. The current transformer may be utilised for low voltage, medium voltage, high voltage applications, and very high voltage applications up to for example 1100 kV.

The inventive concept has mainly been described above with reference to a few examples. However, as is readily appreciated by a person skilled in the art, other embodiments than the ones disclosed above are equally possible within the scope of the inventive concept, as defined by the appended claims.

1. A current transformer comprising:
a bushing,
a primary conductor extending inside the bushing, which primary conductor is electrically insulated with a primary conductor insulation, and which primary conductor comprises a hairpin portion which is arranged outside the bushing,
a tube arranged around the primary conductor along the hairpin portion,
an electrically insulating material arranged in the tube, which electrically insulating material is arranged around the primary conductor insulation in the hairpin portion,
a core arranged around the tube, and
a secondary winding wound around the core.

2. The current transformer as claimed in claim 1, wherein the electrically insulating material comprises a dielectric liquid.

3. The current transformer as claimed in claim 2, wherein the dielectric liquid contained in the tube is oil.

4. The current transformer as claimed in claim 1, wherein the electrically insulating material comprises a quartz filling.

5. The current transformer as claimed in claim 1, wherein the primary conductor is hollow and has an inner channel along the entire primary conductor, wherein the current transformer comprises a dielectric liquid in the inner channel, arranged to circulate in the primary conductor.

6. The current transformer as claimed in claim 5, wherein the primary conductor insulation comprises paper and foil.

7. The current transformer as claimed in claim 1, comprising a frame assembly, wherein the hairpin portion is arranged within the frame assembly.

8. The current transformer as claimed in claim 7, wherein the frame assembly defines an open casing of the hairpin portion.

9. The current transformer as claimed in claim 7, wherein the tube is attached to the frame assembly.

10. The current transformer as claimed in claim 1, wherein the tube is flexible enough to enable threading of the tube onto the hairpin portion of the primary conductor.

11. The current transformer as claimed in claim 9, wherein the tube is made of stainless steel.

12. The current transformer as claimed in claim 1, wherein the bushing is filled with a dielectric fluid.

13. The current transformer as claimed in claim 12, wherein the dielectric fluid is oil.

14. The current transformer as claimed in claim 1, wherein the bushing is filled with air.

15. The current transformer as claimed in claim 1, wherein current transformer is a high voltage current transformer.

16. The current transformer as claimed in claim 2, wherein the electrically insulating material comprises a quartz filling.

17. The current transformer as claimed in claim 2, wherein the primary conductor is hollow and has an inner channel along the entire primary conductor, wherein the current transformer comprises a dielectric liquid in the inner channel, arranged to circulate in the primary conductor.

18. The current transformer as claimed in a claim 2, comprising a frame assembly, wherein the hairpin portion is arranged within the frame assembly.

19. The current transformer as claimed in claim 10, wherein the tube is made of stainless steel.
